(19) United States
(12) Patent Application Publication
(10) Pub. No.: US 2003/0069764 A1
(43) Pub. Date: Apr. 10, 2003

(54) Selling best available seats at a public facility

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/971,230

(22) Filed: Oct. 4, 2001

(51) Int. Cl. G06F 17/60

(52) U.S. Cl. 705/5

(57) ABSTRACT

A virtual ticket control system that controls admission of customers to a public facility. The virtual ticket control system comprises: 1) a plurality of terminal devices disposed at entry points to the public facility, a first one of the terminal devices for establishing a communication link to a virtual ticket device used by a customer and receiving a virtual ticket transmitted by the virtual ticket device; and 2) a virtual ticket authentication controller for receiving the received virtual ticket from the first terminal device and determining if a unique identifier associated with the received virtual ticket matches one of a plurality of stored unique identifiers associated with a plurality of authorized virtual ticket records stored in a memory associated with the virtual ticket authentication controller. In response to a determination that the unique identifier associated with the received virtual ticket matches one of the plurality of stored unique identifiers, the virtual ticket authentication controller transmits to the first terminal device an authorization message indicating that the received virtual ticket is valid.

### CROSS-REFERENCE TO RELATED APPLICATIONS

The present invention is related to those disclosed in the following U.S. patent applications:

1. Ser. No. ______ [Docket No. US 010494], filed concurrently herewith, entitled “SYSTEM FOR DISPLAYING PERSONAL MESSAGES AT A PUBLIC FACILITY AND METHOD OF DOING BUSINESS USING SAME”;

2. Ser. No. ______ [Docket No. US 010495], filed concurrently herewith, entitled “SYSTEM AND BUSINESS METHOD FOR OFFERING SEAT UPGRADES TO PATRONS AT A PUBLIC FACILITY”;

3. Ser. No. ______ [Docket No. US 010496], filed concurrently herewith, entitled “BUSINESS METHOD AND SYSTEM FOR COMMUNICATING PUBLIC-FACILITY STATUS INFORMATION THROUGH A VIRTUAL TICKET DEVICE”;

4. Ser. No. ______ [Docket No. US 010497), filed concurrently herewith, entitled “TICKET EXCHANGE SYSTEM AND METHOD OF OPERATION”;

5. Ser. No. ______ [Docket No. US 010498], filed concurrently herewith, entitled “PUBLIC VENUE AUCTION SYSTEM AND METHOD OF OPERATION”;

6. Ser. No. ______ [Docket No. US 010499], filed concurrently herewith, entitled “SYSTEM AND METHOD FOR SELLING GOODS TO CUSTOMERS OF A PUBLIC FACILITY”; and

7. Ser. No. ______ [Docket No. US 010500], filed concurrently herewith, entitled “SYSTEM AND METHOD FOR SELLING IMAGE-DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to electronic ticket control systems and, more specifically, to a system and method for selling and controlling admission to a large public

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

However, large public facilities tend to be labor intensive operations. A typical sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to offset the high labor costs associated with large public facilities.

There is therefore a need in the art for technical improvements that reduce the costs of operating large public entertainment facilities. In particular, there is a need for new technologies that help to reduce labor costs associated with a operating large public facilities. Additionally, there is a need for technical improvements that enhance the revenues of large public facilities. More particularly, there is a need for new technologies that provide useful and enjoyable services to the patrons of large public facilities.

### SUMMARY OF THE INVENTION

To address the above-discussed deficiencies of the prior art, it is a primary object of the present invention to provide a method and system which allows a facility operator to increase revenue by selling customers optional guaranteed advance admission to the best seat in the facility which remains available at the time of a future event. The method and system make advantageous use of a virtual ticket device.

In its simplest form, the virtual ticket device is an existing smart telephone or cellular communication-enabled personal digital assistant (PDA), such as a PALM PILOT™ or a VISOR™ electronic organizer, a portable video game controller or a portable personal computer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

The encrypted admission authorization record may include, for example, information which identifies the date and location of the event, the seat number, price paid, and the like. The encrypted admission authorization record also may include uniquely encrypted information which may be used in a conventional manner to authenticate that the record is genuine. The same information is preferably stored in a central database which is accessible by the event operator and/or his service provider. The record in the database should preferably also include the telephone number or wireless address of the virtual ticket device so that contact with the virtual ticket device may be established at a later time.

Entry point terminals are provided at the entrances of the public entertainment facility which read at least the encrypted authentication information from the virtual ticket device and authorize the customer to enter the event. The entry point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry point terminal.

Preferably both the virtual ticket device and the arena or theater is also equipped with hardware and software which can track the location of the virtual ticket device in and around the entertainment facility with a precision of perhaps a few meters. Once the customer has purchased a virtual ticket, the virtual ticket device can be used, in conjunction with information stored in the database to provide a number of distinct information and marketing services to the customer.

A virtual ticket control system interoperates with the above-described virtual ticket devices. The virtual ticket control system controls admission of customers to a public facility. According to an advantageous embodiment of the present invention, the virtual ticket control system comprises: 1) a plurality of terminal devices capable of being disposed at entry points to the public facility, a first one of the terminal devices capable of establishing a communication link to a virtual ticket device used by a customer and receiving a virtual ticket transmitted by the virtual ticket device; and 2) a virtual ticket authentication controller capable of receiving the received virtual ticket from the first terminal device and determining if a unique identifier associated with the received virtual ticket matches one of a plurality of stored unique identifiers associated with a plurality of authorized virtual ticket records stored in a memory associated with the virtual ticket authentication controller. In response to a determination that the unique identifier associated with the received virtual ticket matches one of the plurality of stored unique identifiers, the virtual ticket authentication controller transmits to the first terminal device an authorization message indicating that the received virtual ticket is valid.

### BRIEF DESCRIPTION OF THE DRAWINGS

FIG. 1 is a plan diagram of an entertainment venue in which an electronic ticket control system according to the principles of the present invention may be deployed;

FIG. 2 illustrates a virtual ticket device which is capable of interacting with an electronic ticket control system according to the principles of the present invention;

FIG. 3 illustrates a virtual electronic ticket displayed on the virtual ticket device in FIG. 2 according to one embodiment of the present invention;

FIG. 4 illustrates an electronic ticket control system according to one embodiment of the present invention; and

FIG. 5 is a flow diagram illustrating the operation of the electronic ticket control system and the virtual ticket device according to one embodiment of the present invention.

### DETAILED DESCRIPTION OF THE INVENTION

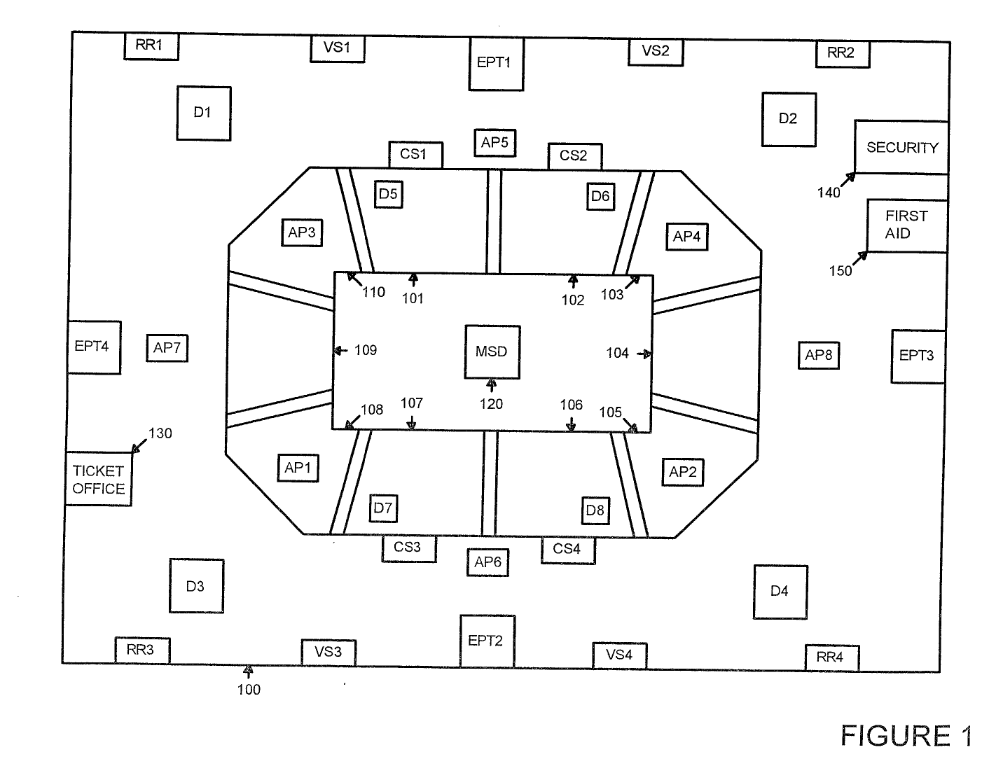

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged communications network capable of communicating with virtual ticket devices.

FIG. 1 is a plan view of public facility 100 in which an electronic ticket control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. However, for the purpose of simplicity in explaining the principles of the present invention, it shall be assumed that public facility 100 is a sports facility.

Public facility 100 comprises a plurality of seating areas, including exemplary seat sections 101-110, that surround a playing area (e.g, hockey rink, basketball court, indoor track, or the like). Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like

Each of entry point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100. EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers similar to the base stations of a cellular telephone system that provide two-way radio frequency (RF) communication links with virtual ticket devices within public facility 100. Preferably, AP1-AP8 have a hand-off capability that allows a customer to roam throughout public facility 100 without losing communication with the electronic ticket control system. Advantageously, this allows the electronic ticket control system to continually track the location of each virtual ticket device in public facility 100.

Customers can use their virtual ticket devices to signal their present location within public facility 100 to friends and to locate lost family members. A network of entry point terminals may be used within public facility 100 to authorize admission to various areas such as preferred seating sections, clubs, luxury boxes, reserved rest rooms, priority parking lots, and the like.

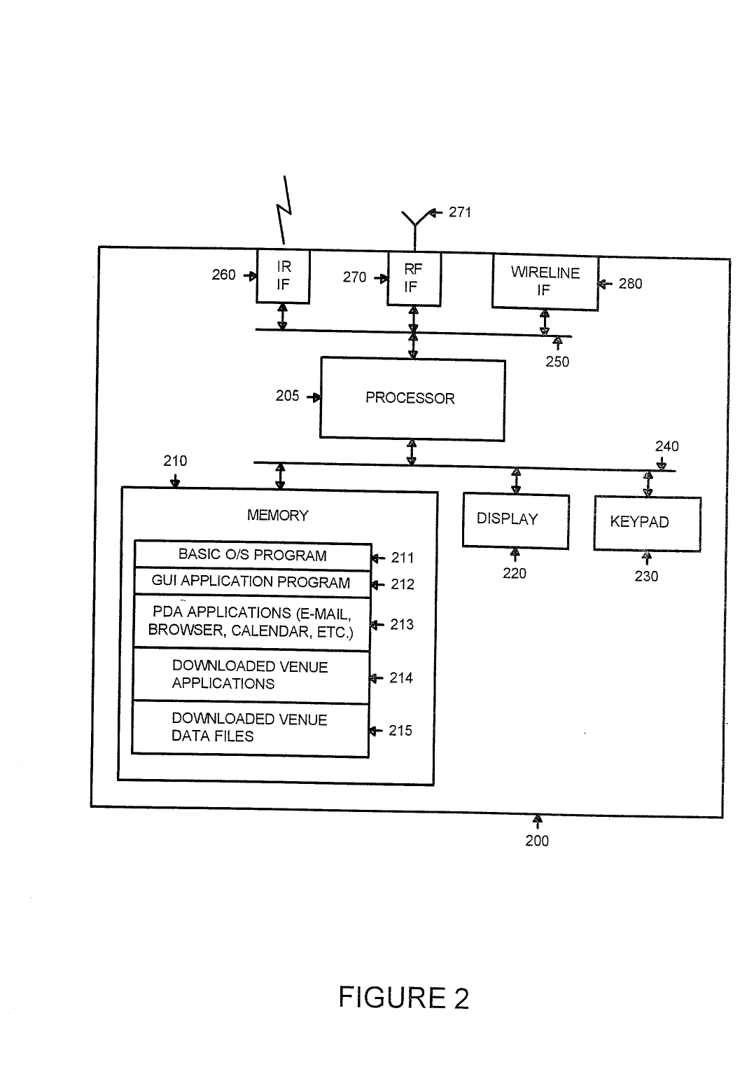

FIG. 2 illustrates virtual ticket device 200, which is capable of interacting with an electronic ticket control system according to the principles of the present invention. Virtual ticket device 200 comprises processor 205, memory 210, display 220, keypad 230, and one or more communication interfaces, including infrared (IR) interface (IF) 260, radio frequency (RF) interface (IF) 270, and wireline interface (IF) 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (O/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces, namely, infrared interface 260, radio frequency interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VII™ organizer. As those skilled in the art are aware, a Palm VII™ organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210. One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

In accordance with the method of the invention the facility operator offers his customers an option to purchase in advance admission to the best seat in the facility that remains unsold and available when the customer arrives at a future event and charges the customer a small premium for this option. If the customer elects to pay for the best available seat option, then partial admission data is loaded into the virtual ticket device at the time of purchase and this data is supplemented and completed at the time of the event in a manner described below. The premium, together with the price of a general admission ticket may be charged to the customer at the time of advance purchase. When the customer enters the facility he may be charged an additional fee which depends upon the grade and location of the best available seat. Typically, the additional fee will be somewhat discounted from the price the customer would have been charged had he purchased a guaranteed ticket in advance for the same seat. As an optional feature, the customer may also specify in advance the a maximum additional amount he is willing to pay at the time of admission and the operator determines the best available seat by taking this maximum price into account. Thus, as used herein, the term “best seat available may mean the best seat within a particular price range.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

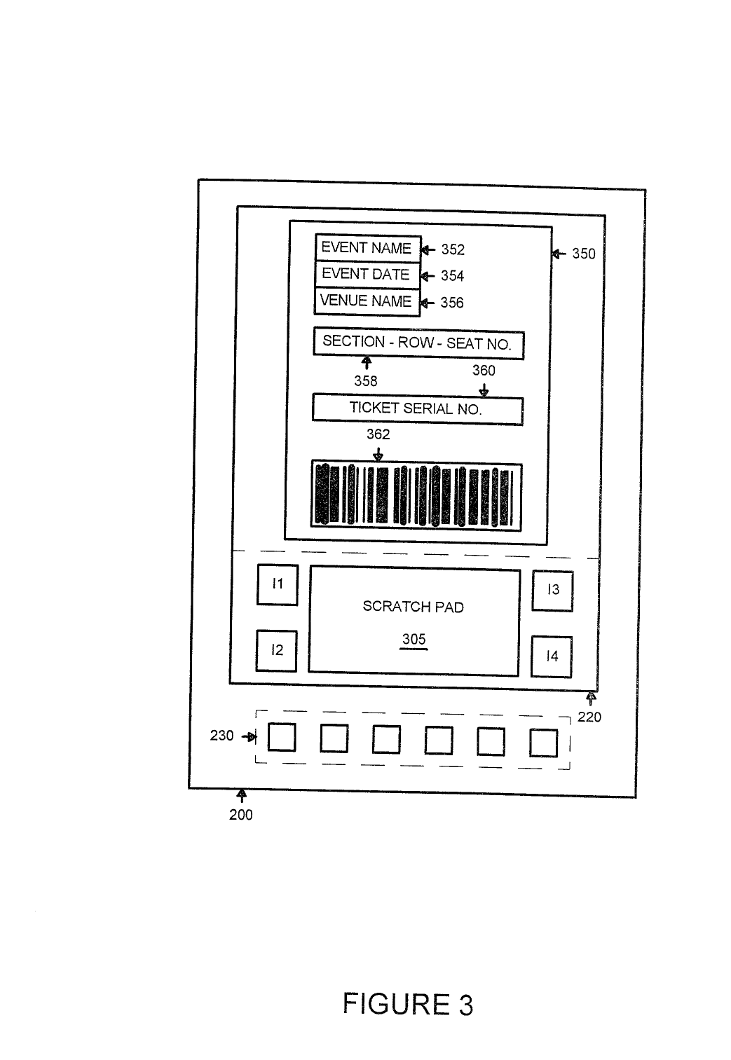

FIG. 3 illustrates virtual electronic ticket 350 displayed on virtual ticket device 200 according to one embodiment of the present invention. Virtual ticket device 200 comprises display 220, and keypad 230. The lower portion of display 220 contains scratch pad 305 and a plurality of icons, namely icons 11, 12, 13, and 14. The upper portion of display 220 contains virtual electronic ticket 350. Virtual electronic ticket 350 comprises event name field 352, event date field 354, venue name field 356, seating information field 358, ticket serial number field 360, and bar code field 362.

The operator of virtual ticket device 200 may use a stylus or a similar device to select icons I1, I2, I3 or I4 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like.

When the customer approaches or enters public facility 100, the customer turns on virtual ticket device 200 and launches the communication application in downloaded venue applications 214 that allows virtual ticket device 200 to communicate with entry point terminals EPT1-EPT4 and access points AP1-AP8 in public facility 100. The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.”

Venue name field 356 contains the name of public facility 100, such as “Madison Square Garden.” Seating information field 358 contains the section, row and seat number information associated with virtual electronic ticket 350.

According to the present invention, seating information field 358 may contain a generic “best available” code or similar indicate instead of the section, row and seat number information. According to such an embodiment, when a customer initially purchases his or her ticket, the customer has the option of paying a small premium to get a virtual ticket for the best available seat. The downloaded virtual ticket stored in virtual ticket device 200 is equivalent to a general admission seat and may not contain a specific seat assignment. When the customer enters public facility 100, if a seat better than the general admission seat is available, the location of the best available seat may be transmitted to virtual ticket device 200 an inserted into the appropriate fields in virtual electronic ticket 350. The customer may then be charged an additional amount according to the price difference between the original general admission seat and the best available seat.

If the entry point terminal contains an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry point terminal accesses the data base associated with the electronic ticket control system associated with public facility 100 and, if virtual electronic ticket 350 is properly authenticated, permits the customer to enter public facility 100. The entry point terminal may produce a visible or audible signal approving entry by the customer. Alternatively, if virtual electronic ticket 350 is not authenticated, the entry point terminal may generate an audible or visual alarm alerting a nearby gate attendant that the customer should not be admitted to public facility 100.

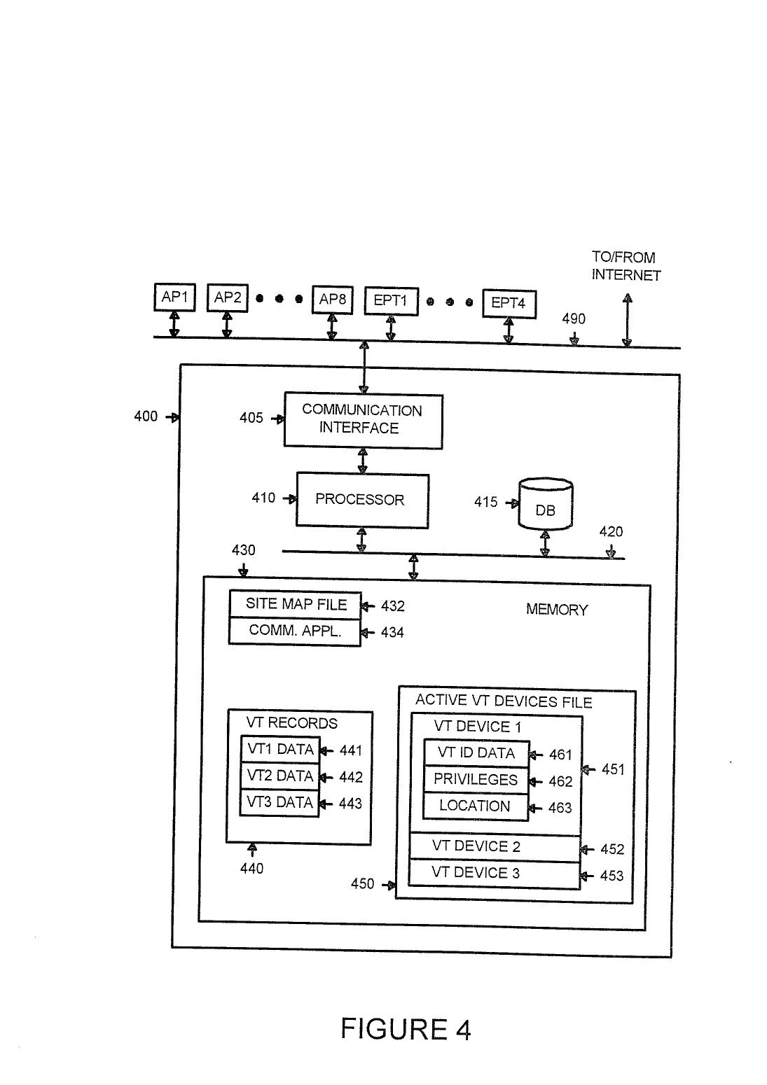

FIG. 4 illustrates electronic ticket control system 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry point terminals EPT1-EPT4. Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Site map file 432 may comprise, among other things, a master seat list of every seat in public facility 100, including a flag indicator for each seat indicating whether or not the seat has been sold or is still available. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket (or a code indicating that the virtual ticket is for a “best available” seat), payment information (optionally), the privileges associated with each virtual ticket, and the like. The virtual tickets that are received from the virtual ticket devices are compared to the virtual ticket data in virtual ticket records 440 before admitting each customer to public facility 100. If a customer has purchased a best available virtual ticket, electronic ticket control system 400 can determine from the master seat list stored in site map file 432 which seat is the best unsold seat and can transmit the corresponding seat information to virtual ticket device 200.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451-453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloaded to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

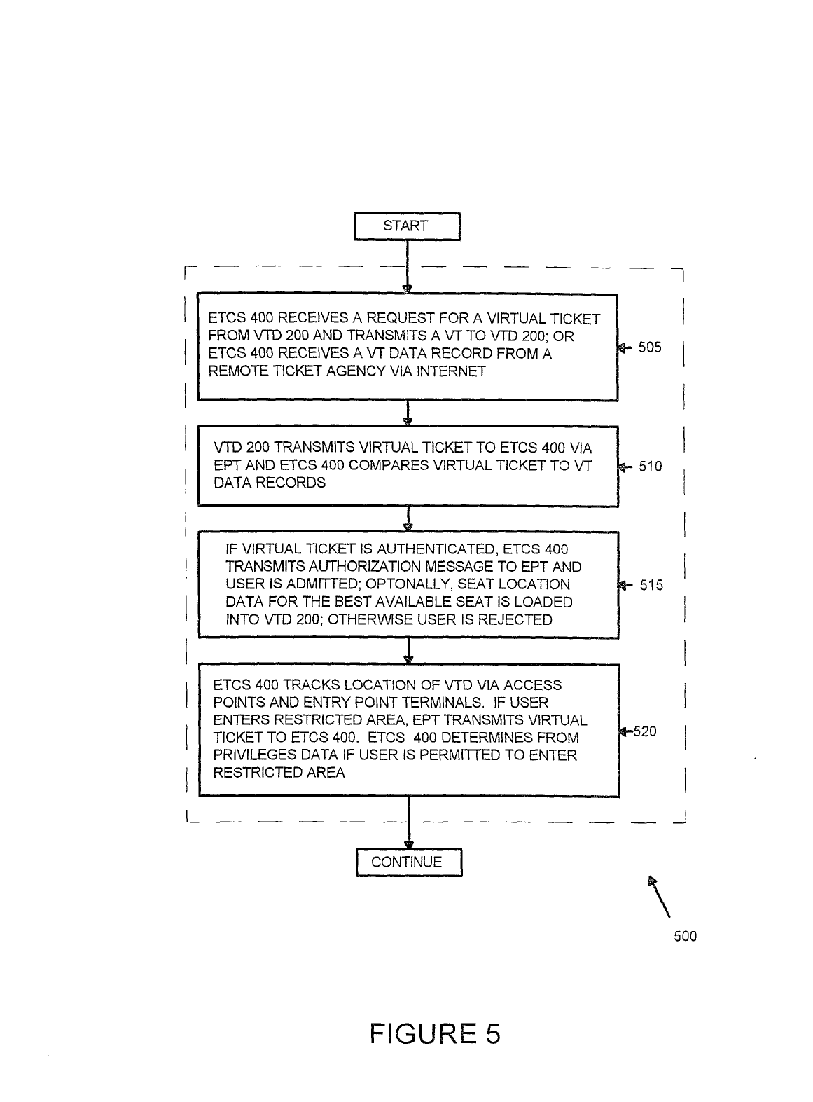

FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user finally arrives at public facility 100 to attend the event, virtual ticket device 200 transmits the virtual ticket stored in virtual ticket device 200 to electronic ticket control system 400 via an entry point terminal. Electronic ticket control system 400 then compares the virtual ticket to the virtual ticket data records 440 stored in memory 430 or database 415 (process step 510). If the virtual ticket is authenticated, electronic ticket control system 400 transmits an authorization message to the entry point terminal and the user is admitted. Optionally, if the user has purchased a best available seat, electronic ticket control system 400 transmits a specific seat assignment to virtual ticket device 200 and, also optionally, charges the user an additional premium. Otherwise, the user is rejected (process step 515).

During the event, electronic ticket control system 400 may track the location of virtual ticket device 200 via the numerous access points and entry point terminals. If the user attempts to enter a restricted area, such as a private restaurant, a luxury box, or a premium seating area, the entry point terminal at the restricted area transmits the virtual ticket to electronic ticket control system 400. Electronic ticket control system 400 determines from the privileges data whether or not the user is permitted to enter the restricted area (process step 520).

What is claimed is:

1. A method of doing business comprising:
receiving an electronic message which authorizes payment for admission to a future event at a public facility;
transmitting admission authorization signals for the event to a virtual ticket device, the authorization signals causing an admission authorization message to be stored in the virtual ticket device;
at the time of the event, receiving a communication of the admission authorization message from the virtual ticket device at a terminal device which is located at an entrance of the facility;
checking the authenticity of the communicated authorization message;
admitting a person in possession of the device to the facility if the message is authentic; and
modifying the admission authorization message to include a specific seat location corresponding to a best seat available at the time of admission.

2. The method of claim 1 further including the step of charging the customer an extra fee for the right to be admitted to the best seat available.

3. The method of claim 1 wherein the extra fee is charged at the time the payment is authorized.

4. The method of claim 1 further comprising the step of charging the customer an additional fee the amount of which depends on the best seat available at the time of admission.

5. The method of claim 4 wherein the amount of the additional fee represents a discount from the usual advance purchase price of the available seat.

6. The method of claim 1 wherein the best seat is the best seat within a specified price range.

7. The method of claim 6 further comprising the step of receiving a message from the device which specifies the price range.

8. The method of claim 1, wherein the virtual ticket device is chosen from the group comprising telephones, personal data assistants, portable video game controller, portable computers and their equivalents.

9. The method of claim 8 further comprising the step of downloading to the virtual ticket device a software program that enables the device to transmit the payment authorization message and to receive the authentication signal.

10. A virtual ticket control system for controlling admission of customers to a public facility comprising:
a plurality of terminal devices capable of being disposed at entry points to said public facility, a first one of said terminal devices capable of establishing a communication link to a virtual ticket device used by a customer and receiving a virtual ticket transmitted by said virtual ticket device; and
a virtual ticket authentication controller capable of receiving said received virtual ticket from said first terminal device and determining if a unique identifier associated with said received virtual ticket matches one of a plurality of stored unique identifiers associated with a plurality of authorized virtual ticket records stored in a memory associated with said virtual ticket authentication controller and, in response to a determination that said unique identifier associated with said received virtual ticket matches one of said plurality of stored unique identifiers
transmitting to said first terminal device an authorization message indicating that said received virtual ticket is valid; and
modifying the virtual ticket to include a specific seat location corresponding to a best available seat at the time of admission.

11. The virtual ticket control system as set forth in claim 10 wherein said virtual ticket authentication controller is further capable of transmitting to said first terminal device at least one of a data file and an application program for subsequent transmission to said virtual ticket device via said communication link.

12. A method of controlling admission of customers to a public facility comprising the steps of:
establishing a communication link between a virtual ticket device used by a customer and a first one of a plurality of terminal devices capable of being disposed at entry points to the public facility;
receiving a virtual ticket transmitted by the virtual ticket device;
determining if a unique identifier associated with the received virtual ticket matches one of a plurality of stored unique identifiers associated with a plurality of authorized virtual ticket records stored in a memory; and
in response to a determination that the unique identifier associated with the received virtual ticket matches one of the plurality of stored unique identifiers;
transmitting to the first terminal device an authorization message indicating that the received virtual ticket is valid; and
modifying the virtual ticket to include a specific seat location corresponding to a best available seat.

13. The method as set forth in claim 12 comprising the further steps of transmitting at least one of a data file and an application program to the virtual ticket.

14. A virtual ticket device comprising:
a memory storing a virtual ticket operable to gain admission to a public facility; and
a communication controller programmed to establish a communication link to a terminal device associated with said public facility, to transmit said virtual ticket to said terminal device for authentication, and to receive from said terminal device specific seat location information associated with a best available seat in said public facility, wherein said communication controller modifies said virtual ticket to incorporate said specific seat location information.

15. A virtual ticket device comprising:
a memory storing a virtual ticket operable to gain admission to a public facility; and
a data processor coupled to said memory and capable of retrieving said virtual ticket from said memory and displaying said virtual ticket on a display of said virtual ticket device in a format capable of being optically scanned by a terminal device associated with said public facility, and wherein said data processor is further capable of receiving from said terminal device specific seat location information associated with a best available seat in said public facility, wherein said data processor modifies said virtual ticket to incorporate said specific seat location information.

16. The virtual ticket device as set forth in claim 8 further comprising a download controller capable of accessing a remote server and retrieving said virtual ticket from said remote server.

17. A method of operating a virtual ticket device to gain access to a public facility comprising the steps of:
storing in a memory associated with the virtual ticket device a virtual ticket operable to gain admission to the public facility;
establishing a communication link to a terminal device associated with the public facility;
transmitting the virtual ticket to the terminal device;
comparing the transmitted virtual ticket to a plurality of virtual ticket records stored in a database associated with the public facility;
transmitting to the virtual ticket device specific seat location information associated with a best available seat in the public facility and modifying the virtual ticket to incorporate the specific seat location information; and
transmitting an authorization message to the terminal device authorizing an operator of the virtual ticket device to enter the public facility if the transmitted virtual ticket matches one of the virtual ticket records; and.
